(19) United States
(12) Patent Application Publication
(10) Pub. No.: US 2009/0119091 A1
(43) Pub. Date: May 7, 2009

(54) Automated pattern based human assisted computerized translation network systems

(76) Inventor: Eitan Chaim Sarig, Modin (IL)

Correspondence Address: Eitan Chaim Sarig, 22/1 Nachal Chever Street, Modin, 71700, IL

(21) Appl. No.: 12/287,829

(22) Filed: Oct. 14, 2008

Related U.S. Application Data
(60) Provisional application No. 60/996,116, filed on Nov. 1, 2007.

(51) Int. Cl. G06F 17/20; G10L 11/00; G06F 17/18

(52) U.S. Cl. 704/2; 704/277; 704/8; 704/E13.011

(57) ABSTRACT

A system and method for automated languages translation comprising a database containing pre-translated patterns that were translated by human translators, generating a transparent and seamless translation service. Whenever a user issues a translation request, the system offers suitable translated sentences from the aforementioned database. The system does so by separating the submitted text into elements and using a pattern recognition mechanism to identify a matching translation to each element. If there is no matching translated pattern in the database or if the user does not approve the translated sentence, the system transparently uses a suitable registered human translator to translate. The new translation is stored in the database, thus perfecting the database, and the translation request is delivered.

### FIELD OF THE INVENTION

The present invention relates to an improved computerized translation network system. More particularly, the invention relates to a system and method that uses a networked translation database enhanced by human translators to create a seamless single unit between the computer and human translators that transparently provides a text based translation service to the user in the requested language.

### BACKGROUND OF THE INVENTION

Achieving high quality translations using computerized systems has been an ongoing challenge for many years. Computer assisted translations are commonly used by professionals in order to save translation time and are more cost effective.

Presently available computerized translation systems are comprised of machine translations and computer aided translations. Machine translations are purely automated translations that are performed by a computer using extremely large dictionaries. Some of the machine translations are provided with grammar engines that are adapted to follow the grammatical differences between the two languages. However, the machine translations are considered too limited for practical purposes in view of the poor quality of their translations. Translations produced by machine translations do not provide the user with precise information about the text being translated. Rather, usually such translations provide the user only with a general idea of the text being translated.

Computer assisted translations are technically performed by human translators wherein translation of sections of the text are performed automatically by the computer. The human translator, then, goes over the computer translated sections and verifies the quality of the translation. The computer assisted translations are commonly used by professional translators and are used in order to save translation time.

A language translating system using a hybrid network of human and machine translators is described in PCT International Publication Number: WO2007070558. In this system, translations are produced statistically, first by breaking input source text into fragments, sending each fragment redundantly to a number of translators with varying levels of reputation, collecting the translation responses and assembling the suggested translations into an overall source speech or text translation based on the translator reputation of each translator. This system specifically relies on the reputation of the translator to achieve the desired translation result.

PCT International Publication Number: WO2006055636 uses direct interactions between users and human translators in an electronic marketplace.

US Application Publication Numbers: US2003/0140316 and US2005010419 describe the use of human translators and automated translation tools.

None of the mentioned patent application publications using a combination of human and machine translation systems offer suitable translations to users through a database of pre-translated patterns enhanced by human translators as the present invention does. This invention meets the need for an alternative computerized human assisted translation system that separates user submitted text into elements and using a pattern recognition mechanism, identifies a matching translation to each element and in the event of a non-match or partial-match, the submitted text is transparently posted to suitable registered human translators from a group of designated translators. The new translation presented by the human translator is then stored in the pattern translation database, thus perfecting the database, and becoming available to the requestor.

### SUMMARY OF THE INVENTION

The present invention achieves the high quality of professional human translations using a semi automated computerized translation network that utilizes a text pattern oriented database. The computerized translation network comprises a dedicated database that is made available to the users via the Internet and stores a bulk of constantly updated translations of pre-used lingual patterns. These patterns may refer to any grammatical format, semantic utilization, idiom, expression and the like. The network further comprises an automated access to a plurality of human translators and a means of communicating between them and the dedicated database. The human translators are approached and assigned with a translation task whenever the network detects that the quality of the translation that may be produced by the dedicated database is not sufficient. After the text is translated by the human translators, new text patterns in the new translation are detected and stored in the dedicated database for future translations.

Embodiments of the present invention provide a data processing system, a computer implemented method, and a computer program product for supporting a computerized human assisted translation network.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 shows a flowchart depicting the steps of the method according to some embodiments of the present invention; and

FIG. 2 shows a schematic block diagram depicting the elements of the system and the architecture according to some embodiments of the present invention.

The drawings together with the description make apparent to those skilled in the art how the invention may be embodied in practice. Further, where considered appropriate, reference numerals may be repeated among the figures to indicate corresponding or analogous elements.

### DETAILED DESCRIPTION OF THE INVENTION

The present invention discloses a computer implemented method, data processing system, and computer program product for providing a natural language human aided computerized translation network. At the heart of the invention lies a dedicated text patterns oriented database that is made accessible to the users through a patterns translation server via the Internet. The dedicated database holds an ever updated bulk of text patterns that are readily translated and verified by human translators. Any user connected to the network may submit a service translation request (such as text translation, email translation, Website embedded translation, etc.) of his or her choice through the network interface. The text to be translated is then broken into short lingual sections. The dedicated database is then searched for each and every lingual section in order to identify a text pattern. Searches with alternate broken sections are also performed for the best possible match. Each identified pattern is translated automatically wherein unidentified sections with or without the identified patterns, are assigned to human translators for translation. The translated sections are then put together, the database is updated and the translation seamlessly becomes available to the user. Each newly translated section is stored within the dedicated database defining a new text pattern.

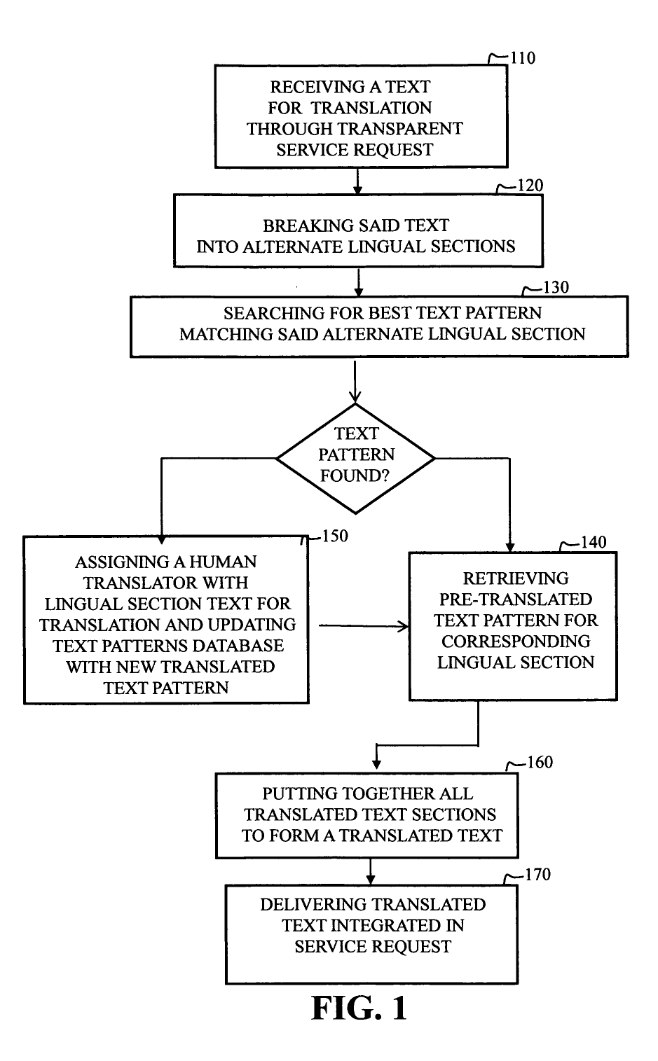

FIG. 1 shows a flowchart depicting the steps of the method according to the present invention. First, a request for a translation service is received 110. The text is then broken into alternate lingual sections 120. Then, each alternate lingual section is searched 130 for the best match. If the lingual section is found, the pre-translated patterns are retrieved 140. If the section is not found, the section is seamlessly and transparently assigned to a human translator for translation, the database is updated 150, and the translated patterns are retrieved 140. Then all the translated sections are collected and put together as a translated text 160, which subsequently becomes available as the service translation request to the user 170.

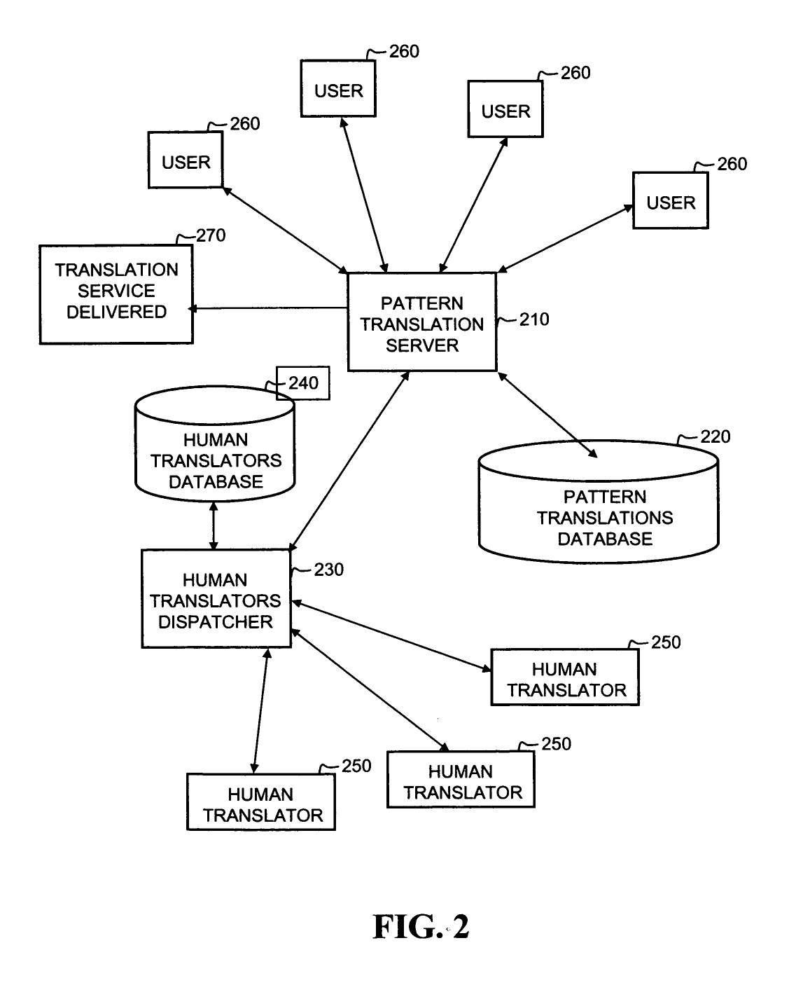

FIG. 2 shows a schematic block diagram depicting the elements of the disclosed data processing system according to some embodiments of the present invention. The schematic block diagram in FIG. 2 shows a computerized human assisted translation network. The network comprises a pattern translation server 210 connected to a dedicated pattern translations database 220 and to a human translators database 240 via a human translators dispatcher 230. The pattern translation server 210 is made available to users 260 via the Internet.

The pattern translation server 210 is configured to receive service translation requests from users 260 over the Internet, breaks the texts into alternate lingual sections and for each lingual section scans the dedicated translated patterns database 220 for pre-translated patterns. The dedicated pattern translation database 220 is used by the pattern translation server 210 to retrieve the translation for the corresponding lingual section. The scanning of the dedicated pattern translation database 220 is performed by pattern recognition techniques as well as text recognition algorithms.

Whenever a corresponding pattern is not found for a certain lingual section, the section or full text is seamlessly and transparently assigned for translation to a human translator 250 chosen from the human translators database 240 by the human translators dispatcher 230 whereby the translation from the human translator is stored as a pattern on the dedicated pattern translation database, the translation request is performed 270 and the system is ready for future translation requests, making the dedicated pattern translation database 220, a learning database. Alternatively, lingual sections may be sent for human translation if a user does not approve of a translated text.

After having all lingual sections translated and the dedicated pattern translation database is updated, all of the translated lingual sections are put together to form a translated text by the pattern translation server 210, which in turn, delivers the translated translation request 270.

According to some embodiments of the invention, the present invention may be embedded within any conversing environment thus enabling a multi-lingual conversing. Specifically, the present invention enables automated mass direct multi-natural-language conversing. Conversing comprises Email, Chat, Social Networking, Messaging, SMS and the like. The computerized translation network may operate both online and offline and may support a wide variety of objects to be translated. These objects may be text, image, or voice.

According to some embodiments, the human translator 250 may further seamlessly and transparently participate in the translation process by performing additional tasks to assist potential matching. These tasks may comprise: breaking the text into segments (sentence-like) combinations of source and target languages; marking elements that are unique to the specific text and may not repeat in future translation requests (such as initials, names, etc); marking elements that are specially formulated such as headlines, quotations, terms, etc; marking words with alternative synonyms; specifying level of source text to assist potential matching, for example whether it is slang or literature text.

According to some embodiments, the present invention enables the translation from a first language to a second language through a third language. Specifically, the pattern X is asked to be translated from language A to language B. There is no match for this translation in the dedicated pattern translation database 220 however, there is a match from language A to language C and then from language C to language B (or through other languages to sub patterns). This approach can trigger human translators 250 from language C-to-B, and not necessarily from language A-to-B (this means that the human translators database 240 may be much wider). Additionally, this method may be used as a means for performing quality control as well when comparing the translation results among languages and has the ability to translate from different styles within certain languages.

According to some embodiments of the invention, the translation network may be used for proofreading and validating the translations. An additional human translator may be triggered to verify the translation. Alternatively, an additional human translator may be triggered to analyze only the target document without the source or the original translator's name. An approved proofreader is a registered translator with a configurable number of transactions and an appropriate proofreading level. The human translators database 240 may hold data as to the characteristics of the translators such as translation languages, quality, speed and credibility. Assigning the right translators will take into account these properties. In addition, users may rate translations thereby rating the translators. The human translators database 240 is then updated periodically in view of the changing rating of the translators.

In order to further enhance the credibility of the translations offered by the network, translators may be required to pass translation tests and/or be randomly audited. The translators may be classified according to their characteristics as well as the rating defined by the users. Classifying the translators is then used to update the human translators database 240.

Advantageously, the present invention provides the ability to handle erroneous input. Specifically, the network may receive wrong input and still generate a high quality database due to human involvement. The network is able to provide an automated translation of common mistakes, shortcuts, and slang—as it evolves and learns over time. Specifically, Internet Chat and SMS have typical simplistic syntax that can be patterned and mastered through the dedicated translated patterns database 220.

According to some embodiments of the invention, support is provided for a Webmaster developing a Web site in his or her language, or when a user is developing his/her personal page within a social networking space, and would like a specific section to become multilingual. The service offered by the translation network receives the user's request, submits the request to the network, and delivers it translated, and embedded in its Web page.

According to some embodiments of the invention there is provided a Plug-In software component that may be added to an existing Email program (e.g. Microsoft Outlook™). This software component will enable to specify a translation request in an outbound or inbound email. It enables each correspondent to write the email in its own language (that can be a different language) while, the email recipient, is getting it in its own language.

According to some embodiments of the invention there is provided a mechanism for direct mass translation commerce through the pattern translation server 210. Any registered user may submit a translation request and purchase the translation from any registered translator while knowing their translation credentials and transactions. Here also the pattern translation server is involved unless confidentiality prevents the server from functioning as a go between.

Advantageously, the present invention provides a transparent means for users to converse, send messages, send emails, or interact in a social networking in a multi-lingual environment using their own language. Once requesting a translation, the system, through the pattern translation server 210 first attempts to match the requested text pattern to patterns from the dedicated pattern translations database 220. If a pattern is not found then a human translator is requested, the human translator provides a translation, the dedicated translated patterns database 220 is updated, and the requested translation service becomes available to the user from the pattern translation server 210. Once multi-lingual transactions are in place in large quantities, their patterns (origin and target language patterns) are classified and keyed, to form a real-time unattended natural language translator. Applications for such translations can be Chat, SMS, Email, Multilingual widgets, etc.

According to some embodiments of the invention, the system can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks.

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A data processing system for translating texts by breaking said texts into alternate lingual sections and identifying pre-translated text patterns, said data processing system comprising:
a pattern translation server; connected to
a dedicated pattern translations database and;
a human translators database; via
a human translators dispatcher;
wherein said pattern translation server is configured to receive translation request texts from users over the Internet, break said texts into alternate lingual sections and for each lingual section, scan said dedicated database for pre-translated patterns;
wherein said dedicated pattern translations database is used by the pattern translation server to retrieve the translation for the corresponding lingual section;
wherein whenever a corresponding pattern is not found for alternate lingual sections, the sections, are transparently assigned for translation to a human translator chosen from the human translators database by the human translators dispatcher whereby the translation from the human translator is stored as a pattern on the dedicated pattern translations database for future translations;
and wherein the translated lingual sections are put together to form a translated text by the pattern translation server, which in turn, delivers the requested translation service.

2. A data processing system of claim 1 wherein the pattern translation server through the dedicated pattern translations database and the human translators database transparently provides a textual, imaging, or voice service and multilingual conversing through email, chat, social networking, multilingual widgets embedding, messaging, SMS and the like.

3. A computer implemented method for translating texts by breaking said texts into alternate lingual sections and identifying pre-translated text patterns, said computer implemented method comprising the steps of:
receiving a text for translation;
breaking said text into alternate lingual sections;
for each lingual section: searching a text patterns database for a text pattern matching said lingual section;
for each unfound lingual section: seamlessly assigning a human translator with said unfound lingual section or full text for translation and updating said text patterns database with newly translated lingual section
putting together translated lingual sections to form a translated text;
delivering the requested translation service.

4. The computer implemented method of claim 3 wherein the text received for translation may be in an email, chat, social networking, messaging, SMS and the like and the translated lingual sections put together to form a translated text may be delivered to the user in an email, chat, social networking, multilingual widgets embedding, messaging, SMS and the like.

5. A computer program product for translating texts by breaking said texts into alternate lingual sections and identifying pre-translated text patterns, said computer program product comprising:
a computer usable medium having computer usable program code tangibly embodied thereon, the computer usable program code comprising:
computer usable program code for receiving a translation service request;
computer usable program code for receiving a text for translation;
computer usable program code for breaking said text into alternate lingual sections;
computer usable program code for searching alternate text patterns database for a text pattern matching said lingual section;
computer usable program code for transparently assigning a human translator with said unfound lingual section for translation;
computer usable program code for updating said database with newly translated lingual section;
computer usable program code for putting together translated lingual sections to form a translated text;
computer usable program code for delivering said requested translation service.

6. A computer program product of claim 5 wherein the translated text formed when putting together bilingual sections by the computer usable program code may be delivered to the user of an email, chat, social networking, multilingual widgets embedding, messaging, SMS and the like.
